(19) United States
(12) Patent Application Publication
(10) Pub. No.: US 2025/0327917 A1
(43) Pub. Date: Oct. 23, 2025

(54) DYNAMIC AESA RECONFIGURATION

(71) Applicant: Rockwell Collins, Inc., Cedar Rapids, IA (US)

(72) Inventors: James West, Cedar Rapids, IA (US); Venkata Sishtla, Cedar Rapids, IA (US)

(21) Appl. No.: 19/175,298

(22) Filed: Apr. 10, 2025

Related U.S. Application Data
(60) Provisional application No. 63/635,848, filed on Apr. 18, 2024.

(51) Int. Cl. G01S 13/44; G01S 13/02

(52) U.S. Cl. CPC G01S 13/4463; G01S 13/4409; G01S 13/4472; G01S 2013/0254

(57) ABSTRACT

A method is provided for operating a monopulse active electronically scanned array (AESA) radar system on an aircraft. This system includes multiple emitter elements each with corresponding radio frequency (RF) channels including beamforming integrated circuits (BFICs). The method includes defining multiple modes, with each mode defining an effective aperture by specifying a different plurality of the emitter elements, and determining a preferred state of the AESA system based on a flight phase or environment of the aircraft. One of the plurality of modes is identified as corresponding to the preferred state, and beam steering is calibrated via a beam steering controller (BCM) to produce sum, azimuth difference, and elevation difference beams under the constraint of illuminating all of and only the plurality of the emitter elements corresponding to the selected one of the plurality of modes. BFICs of the emitter elements are then energized according to this calibrated beam steering.

### CROSS-REFERENCE TO RELATED APPLICATION(S)

This application claims the benefit of U.S. Provisional Application No. 63/635,848 filed Apr. 18, 2024 for “DYNAMIC AESA RECONFIGURATION” by J. West and V. Sishtla.

### BACKGROUND

The present disclosure relates generally to monopulse radar, and more particularly to systems and methods for mode-based control of active electronically scanned array (AESA) radar systems.

Radar systems, including electronically scanned array (ESA) radar systems, have recently begun to see use in commercial aerospace applications to collect meteorological data. Airborne weather radar can include dedicated weather radar hardware, and/or multipurpose radar systems capable of detecting and identifying relevant weather conditions, but used responsible for other tasks (e.g., collision avoidance, target or surface identification). AESA radar, in particular, offers extremely high resolution at relatively small antenna size by forming multiple beams of radio waves (sum and difference beams) simultaneously, and minimizing composite error signal to locate targets.

Airborne weather radar systems can be used to detect conditions (e.g., weather conditions) and/or objects above, around, or beneath an aircraft. Different environmental conditions, target locations, and imaging tasks can have different optimal radar solutions.

With respect to ground-facing radar, ground clutter in particular poses special challenges to the collection of useful data from downward antenna beams intended to display doppler returns from, e.g., hazardous weather near a landing location. Severe weather close to the ground can pose particularly risks to commercial aircraft at low altitudes. More generally, factors such as wind, precipitation, and surface conditions (e.g., water, ice) can determine appropriate flight behavior. Microbursts and unanticipated wind shear can pose particularly high dangers to descending aircraft during landing, when engine power is reduced and landing gear and flaps are extended, and aircraft total energy state is consequently low. Accurate identification of hazardous weather conditions near the ground allows pilots and/or aircraft systems to land safely without false alerts that might otherwise demand landings be discontinued and reattempted, causing increased fuel consumption and longer flight time.

Radar approaches that are well optimized for specific tasks, such as detection of ground-adjacent atmospheric phenomena, are not necessarily optimal for other purposes. Particular radar arrangements, orientations, and operations that are well-suited to certain tasks may be unnecessarily power-intensive, have undesirable beam characteristics, and/or poor noise discrimination in other contexts.

### SUMMARY

This disclosure presents a method for operating a monopulse active electronically scanned array (AESA) radar system on an aircraft. This system includes multiple emitter elements each with corresponding radio frequency (RF) channels including beamforming integrated circuits (BFICs). The method includes defining multiple modes, with each mode defining an effective aperture by specifying a different plurality of the emitter elements, and determining a preferred state of the AESA system based on a flight phase or environment of the aircraft. One of the plurality of modes is identified as corresponding to the preferred state, and beam steering is calibrated via a beam steering controller (BCM) to produce sum, azimuth difference, and elevation difference beams under the constraint of illuminating all of and only the plurality of the emitter elements corresponding to the selected one of the plurality of modes. BFICs of the emitter elements are then energized according to this calibrated beam steering.

This disclosure also presents an AESA radar system that includes a phased array of independently controllable RF channels, a beamforming module with a beam steering controller (BSC), and a switching module. Each RF channel has an associated emitter element. The switching module is operable to dynamically select between multiple AESA modes, and includes a library of these modes, with each AESA mode specifying a different subset of the RF channels to define an aperture shape by associated emitter elements corresponding to the respective subset of RF channels. The beamforming module is constrained to illuminate all of and only the associated emitter elements of the dynamically selected AESA mode.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a simplified schematic overhead view of an aircraft-mounted monopulse radar system.

FIG. 2 is a schematic system diagram of the monopulse radar system of FIG. 1.

FIG. 3 is a method flowchart describing the process of mode switching for the monopulse radar system of FIGS. 1 and 2.

FIGS. 4a-c are simplified plots of radially symmetric effective aperture geometries and associate radiant plots for the monopulse radar system of FIGS. 1 and 2.

FIGS. 4d-g are simplified plots of trapezoidal effective aperture geometries and associate radiant plots for the monopulse radar system of FIGS. 1 and 2.

FIGS. 4h-j are simplified plots of sparse effective aperture geometries for the monopulse radar system of FIGS. 1 and 2.

FIG. 4k is a simplified plot of a crossed fan beam effective aperture geometry with associated radiant plots for the monopulse radar system of FIGS. 1 and 2.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents methods and systems for dynamically reconfiguring an active electronically scanned array (AESA) radar system. This approach allows switching of the AESA system in-flight between a library of available modes based on imaging task, environment, flight mode, and/or other factors. These modes include different subsets of available AESA emitters elements to be activated, thereby defining an effective aperture shape or pattern as discussed in detail below. Stored modes can also specify polarization and sidelobe orientation of beams. This mode switching functions as a pre-calibration step for AESA operation.

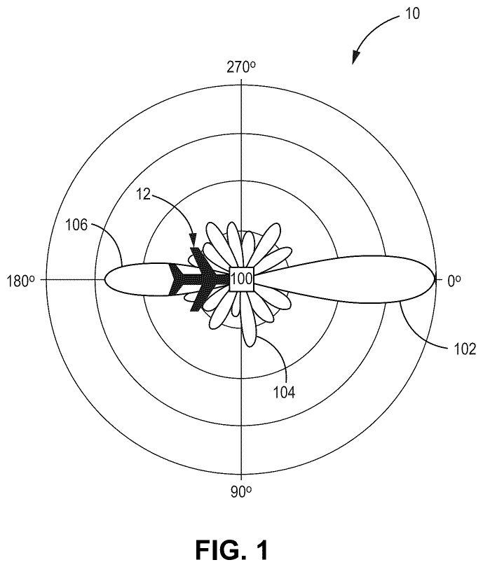

FIG. 1 is a simplified schematic overhead view of radar system 10, an aerial weather radar system. Radar system 10 is disposed on aircraft 12, and includes monopulse radar 100, a three-beam AESA radar system capable of downward, ground-facing imaging while aircraft 12 is in flight. For simplicity of illustration, FIG. 1 depicts only one of the three beams generated by monopulse radar 100. Monopulse radar 100 includes at least one antenna with multiple (e.g., 1,024) discrete elements, each with dedicated RF channels, coordinated as a phased array to generate beams directed to sweep, scan, or otherwise traverse a space that can include surface geography. As shown in the simplified illustration of FIG. 1, radiation making up a beam of monopulse radar 100 is characterized geometrically by multiple lobes. Although a main lobe 102 may be directed at locations of interest by tuning phases and amplitudes of radiation emissions from radio frequency channels of monopulse radar 100, sidelobes 104, including back lobe 106, will unavoidably be produced as well. Sidelobes 104 can contribute to undesirable signal clutter, such as ground clutter. Although back lobe 106 can have high amplitude relative to individual sidelobes 104, back lobe effects are generally less significant to radar performance than sidelobe effects due both to the highly directional nature of “forward looking” AESA radar, and to electromagnetic blockage by the structure of aircraft 12.

Relative sidelobe level (SLL), number, and location/orientation depend on aperture shape of monopulse radar 100. As described in greater detail below, this disclosure presents systems and method for dynamically switching effective aperture geometries and configurations by defining multiple operable modes for monopulse radar 100. By switching between these modes, the approach allows in-flight optimization or specialization of radar for a variety of purposes including, but not limited to, power-aware processing (i.e., power cost reduction), ground clutter suppression, anti-jamming, low probability of intercept, or low probability of detection. Some such modes can adjust sidelobes to, for example, reduce clutter by directing sidelobes away from expected clutter sources (e.g., obliquely with respect to a ground surface, to reduce ground clutter), or reduce maximum SLL.

Although the uses and advantages of radar system 10 and monopulse radar 100 are illustratively described hereinafter principally in terms of hazardous weather detection, it should be understood that radar system 10 can also be used for, and/or include components specialized for imaging of, non-weather phenomenal, including for object detection and identification, collision avoidance, targeting, geolocation data collection, search, and rescue.

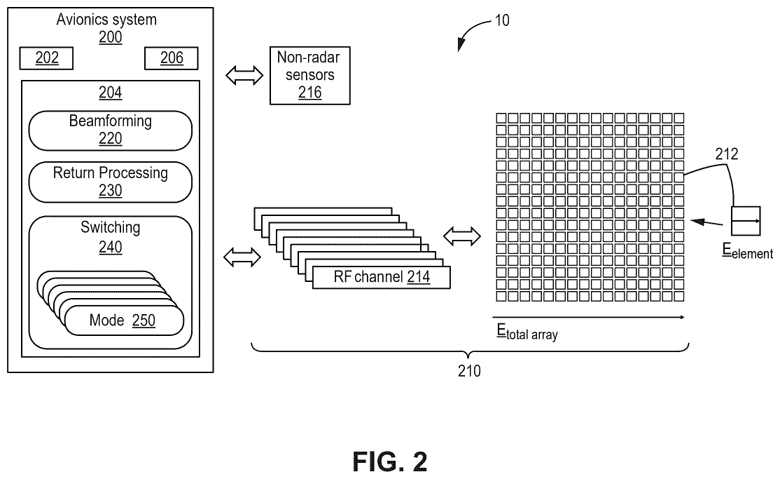

FIG. 2 is a schematic system diagram hardware and logic components of radar system 10. FIG. 2 illustrates avionics system 200 (with processor 202, memory 204, and interface 206) and active electronically scanned array (AESA) 210. AESA 210 can, for example, be a half duplexed Tx and Rx AESA with multiple discrete emitter/receiver elements 212 each having a corresponding dedicated radio frequency (RF) channel 214. Each RF channel 214 can, for example, include a beamforming RF integrated circuit (BFIC) and transmit/receive module (TRM). RF channels 214 are collectively governed and coherently aggregated by hardware, firmware, and software within beamforming module 220 (described below).

Radar system 10 also includes or otherwise receives inputs from non-radar sensors 216. In addition to operating elements of radar system 10 as described below, avionics system 200 can be responsible for other necessary functions of aircraft 12, including tasks related to navigation, communication, and diagnostics, some of which can involve non-radar sensors 216. Further or alternatively, elements illustrated in FIG. 2 as components of avionics system 200 can be offloaded to separate hardware communicatively coupled to, but separable from, avionics system hardware.

Processor 202 is a logic capable device that can execute software, applications, and/or programs stored on memory 204. Examples of processor 202 can include one or more of a processor, a microprocessor, a controller, a digital signal processor (DSP), an application specific integrated circuit (ASIC), a field-programmable gate array (FPGA), or other equivalent discrete or integrated logic circuitry. Processor 202 can be entirely or partially mounted on one or more circuit boards.

Memory 204 is configured to store information and, in some examples, can be described as a computer-readable storage medium. Memory 204, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 204 is a temporary memory. As used herein, a temporary memory refers to a memory having a primary purpose that is not long-term storage. Memory 204, in some examples, is described as volatile memory. As used herein, a volatile memory refers to a memory that that the memory does not maintain stored contents when power to the memory 204 is turned off. Examples of volatile memories can include random access memories (RAM), dynamic random-access memories (DRAM), static random-access memories (SRAM), and other forms of volatile memories. In some examples, the memory is used to store program instructions for execution by the processor. The memory, in one example, is used by software or applications running on server 100 to temporarily store information during program execution. Memory 204 can, in some embodiments, store calibrations for specific AESA, as described in detail below.

Interface 206 is an input and/or output device, set of devices, and/or software interface, and enables avionics system 200 to communicate with other components of monopulse radar 100 and/or radar system 10. In addition, interface 206 can provide means of digital or analog signal communication with other components of aircraft 12, and/or a human interface operable by a human user such as a pilot or technician. In some embodiments, interface 206 can be a machine-to-machine interface such as a transceiver or adapter whereby a user interacting with a remote device can indirectly interface with avionics system 200.

AESA 210 is a phased array, e.g. installed on a common antenna, of multiple discrete RF channels 214 with associated antenna elements 212. Each antenna element 212 and associated RF channel 214 can, in some embodiments, act as both an emitter (i.e., generating components of beams of monopulse radar 100 in cooperation with other RF channels 214 as a phased array) and a receiver (i.e., receiving radar returns for processing by avionics system 200). Active antenna elements 212 collectively define the aperture of AESA 210, and are each capable of radiating an independent signal from respective RF channel 214. As noted above RF channels 214 can at least include a dedicated beam forming integrated circuit (BFIC) and transmit/receive module (TRM) governed by beamforming module 220 (see below). RF channels 214 can have a serial peripheral interface (SPI) or non-serial bus. More generally, however, any appropriate signal channel can be used, so long as each RF channel 214 making up AESA 210 is capable of independent adjustment by and reporting to avionics system 200. As illustrated in FIG. 2, each antenna element 212 shares a common horizontal electric field polarization E with AESA 210, as a whole. More generally, however, other electric field polarizations can be shared by all elements 212 and by AESA 210 as a whole, including vertical or other-angled linear polarizations and/or circular polarizations. Polarization of AESA 210 and activation or deactivation of individual elements 212 can be adjusted based on mode selection through avionics system 200, as described in detail below, to optimize or specialize operation of AESA 210.

In the illustrated embodiment, AESA 210 consists of a multitude of independently controllable RF channels 214 with associated antenna elements 212 distributed in a rectangular arranged on orthogonal axes. More generally, however, physical locations of antenna elements 212 need not always be physically arranged along axes forming independent bases, and alternative array geometries can be simulated at beamforming, notwithstanding physical locations of each antenna element 212.

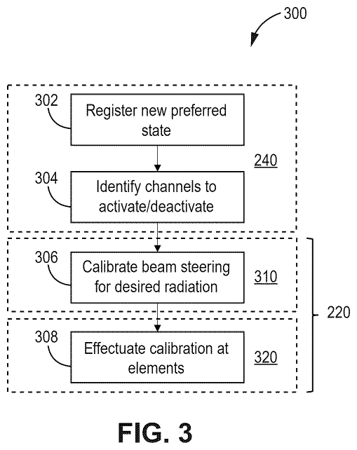

Non-radar sensors 216 can include any sensors coupled to avionics system 200, and not directly affected by the functioning of radar system 10. Non-radar sensors 216 can, for example, include non-radar-based altitude sensors, air data probes, ice detection systems, and landing gear status sensors, to name a few non-limiting examples. As noted below and discussed in greater detail with reference to FIG. 3, sensor data from non-radar sensors 216 can in some embodiments be used to identify conditions for switching modes for AESA 210, and/or to identify preferred modes based, e.g., on mission phase or environment.

Memory 204 is illustrated as hosting several functional software modules 220, 230, and 240. These modules are collectively responsible for controlling radiation emission and processing return signals as known in the art, and are executed by avionics system 200 using processor 202. More specifically, beamforming module 220 is responsible for specifying amplitude and phase or time delay of radiation emission from all RF channels 214 as a phased array to produce multiple monopulse beams, while return processing module 230 is responsible for amplitude- or phase-based comparison of return signals, general noise reduction, and in some embodiments, imaging based on radar returns. Beamforming module 220 can, for example, be or include a beam steering controller (BSC) that collectively controls BFICs of each RF channel 214. In the illustrative embodiments principally described herein, beamforming module 220 defines three beams—a sum beam Σ, and an azimuth difference beam Δₐ, and an elevation difference beam Δₑ. Sum beam Σ can, for example, be defined by a Taylor-weighted beam profile to reduce sidelobe amplitude, while difference beams Δₐ and Δₑ can, for example, be defined by Bayliss-weighted beam profiles, Taylor-weighted beam profiles, and/or split Taylor-weighted beam profiles.

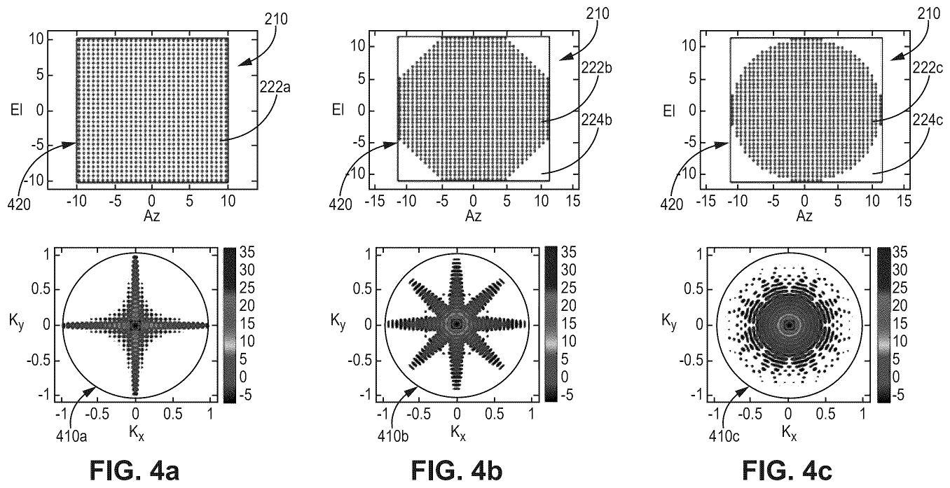

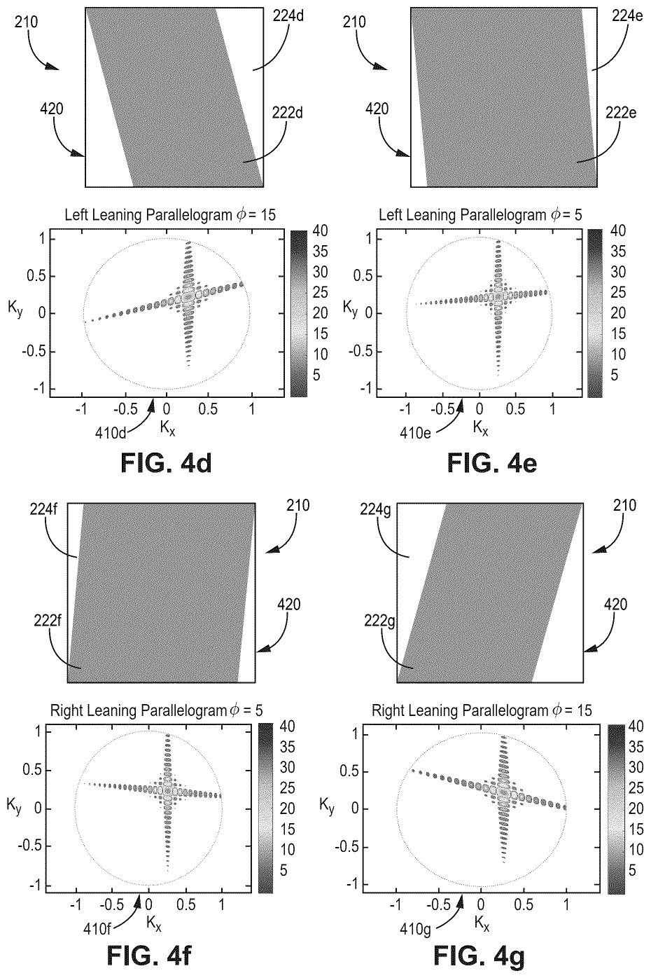

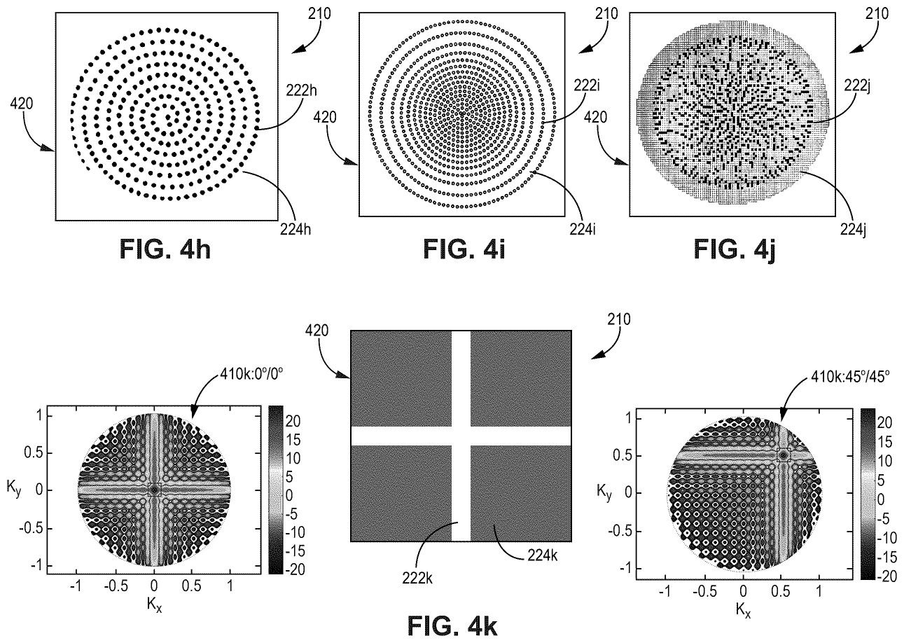

As shown in FIG. 2, memory 204 also hosts switching module 240 with multiple modes 250. Switching module 240 is responsible for identifying triggering circumstances for mode switching, and for effectuating switching between modes 250 based on these circumstances as described in greater detail below with reference to FIG. 3. Each mode 250 at least specifies an effective aperture geometry defined by an active subset of elements 212 and an inactive subset of elements 212 (see FIGS. 4b-4k), and can also specify other parameters such as polarization and beam orientation suitable for that effective aperture geometry and its expected operating conditions. Modes 250 can, for example, be stored as a library, lookup table, or database in memory 204.

Switching module 240 processes inputs from within avionics system 200, e.g., from return processing 230, to determine circumstances matching use cases for specific modes 250. Based on these triggering circumstances, switching module 240 advantageously commands beamforming module 220 to adjust AESA 210 to effectuate corresponding modes 250. This disclosure focuses principally on Tx operation of AESA 210 and selection of corresponding modes 250 by switching module 240, but switching module 240 can also specify modes for Rx operation, which can differ from Tx modes.

Each mode 250 includes an aperture definition consisting of a listing of or pointer to specific RF channels 214 corresponding to specific elements 212 geometrically located within AESA 210 to form a desired aperture geometry for that mode 250. This disclosure refers interchangeably to activating (or deactivating) elements 212 and/or RF channels 214, but it should be understood that elements 212 are activated or deactivated by controlling operation of their respective RF channels 214, i.e., through control signals provided to respective BFICs, rather than through operation of any sort of hardware switch specific located at individual elements 212. An RF channel 214 (or element 212) is described herein as “inactive” or “deactivated” when unpowered throughout operation of a mode 250, and as “active” when powered for Tx operation to generate sum beam Σ and/or difference beams Δₐ and Δₑ through operation of beamforming module 220, or for Rx operation to provide return inputs to return processing module 230.

During operation of system 10, active and inactive subsets of elements 212, and other parameters set by a selected mode 250, act as constraints on operation of beamforming module 220. Beamforming module 220 generates sum and difference beams for AESA operation through adjustment of phase and amplitude of only the subset of elements 212 permitted according to a currently selected mode 250, with mode switching consequently necessitating new and different beamforming operations.

FIG. 3 is a flowchart of method 300 with general hardware context. Method 300 is a method of operation for radar system 10, and more specifically for switching modes of AESA 210 using avionics system 200.

In step 302, switching module 240 registers a new preferred state of AESA 210 corresponding to a mode 250. As noted above with respect to FIG. 2, switching module 240 can determine this preferred state based on multiple factors, including individual and/or aggregated sensor inputs from non-radar sensors 216, processing of radar returns from return processing module 230, and manual inputs, e.g. from a pilot or other operator. In some embodiments step 302 can entail switching module 240 detecting a change in mission phase (e.g., takeoff, cruise, landing) based on aircraft altitude, location, pitch, or landing gear status, as reported by non-radar sensors 216, and/or identifying mission phase a priori based on a known static or multi-phase mission. In other embodiments step 302 can entail switching module 240 identifying weather or other environmental conditions including but not limited to fog, precipitation (by type), or wind based on any combination of non-radar sensors 216 and/or outputs from return processing 230. In still further embodiments step 302 can include responding to a change in task and/or borescope orientation of AESA 210, e.g., from forward or upward to downward (ground-directed), or from wide-beam (narrow aperture) object detection to high-resolution (wide aperture) object identification. More generally, switching module 240 can select among modes 250 based on evolving environmental conditions. In some use cases, modes 250 can be selected at least in part to reduce probability of signal interception or detection, and/or to reduce vulnerability to jamming, in military environments. In other use cases, modes 250 can be selected in response to entering or nearing urban air environments to minimize or compensate for electromagnetic congestion and/or pollution.

In some embodiments switching module 240 can score each mode 250 based on any, all, or a sensor fusion of available sensor data, including data from AESA 210 and non-radar sensors 216. In such embodiments a mode 250 can be selected based on this scoring, e.g., by highest score and/or by score exceeding a corresponding score of the current mode by greater than a threshold value. In other embodiments, certain modes or subsets of modes 250 may be strictly required depending on a specified task or environment. In some such embodiments, scoring can still be used to select from within required subsets of modes 250.

In some embodiments switching module 240 can be capable of enforcing a minimum time between mode switching. In some such embodiments, exceptions to this minimum switching time can be made, e.g., to toggle between different modes 250 for Rx and Tx operation of AESA 210, or to switch to specific allowed modes 250 based on transient events demanding immediate response. In some such embodiments, switching module 240 can identify a preferred state including multiple modes 250 to cycle or switch between, and a periodicity or schedule for mode switching, based on factors as described above.

In step 304, switching module 240 identifies individual channels 214 and corresponding elements 212 to activate or deactivate. More specifically, switching module 240 identifies an active subset of all elements 212 defining an effective aperture for AESA 210 in a selected mode 250 corresponding to the new preferred state of AESA 210, and a complementary inactive subset of elements 212 to be disabled in the selected mode 250. Where the preferred state requires cycling through/alternating between multiple modes 250, switching module 240 identifies channels 214/elements 212 to activate and deactivate for each such mode. Where modes 250 specify further parameters beyond active and inactive subsets of elements 212, such as polarizations and/or orientations, switching module 240 also provides these parameters to beamforming module 220 at step 304. The identification of active elements 212 specified by each mode 250 can consist of a corresponding listing, e.g., retrieved via lookup table by switching module 240, provided to beamforming module 220 as a constraint on operation of BSC 310 and BFIC 320.

In step 306, beamforming module 220 receives constraints from switching module 240 corresponding to the selected mode 250, and BSC 310 produces a calibration for beam steering for desired radiation characteristics. Calibrations 260 can, for example, be digital or analog signal parameters for each active RF channel 214 rapidly selected to substantially produce idealized phases and amplitudes corresponding to sum and difference beams having shape and orientation as necessary for current radar operation, e.g., for desired far field shape. Generally, BSC 310 (and beamforming module 220, generally) can use any approach that generates calibrations capable of driving AESA 210 to produce beams directed as desired, using only elements 212 specified as active according to mode 250, and with other characteristics (e.g., polarization) as set by mode 250. Calibration can advantageously be performed via a FAST Array Test Environment (FATE) methodology using extensions of Hadamard orthomode code. FATE can, for example, compensate for actual hardware nonidentities of active and passive RF circuitry by rapidly mapping all 2^{N} amplitude and 2^{M} phase states available across BFICs and TRMs of RF channels 214 to generate corrections to amplitude and phases satisfying requirements of mode 250 while generating beams with required characteristics (e.g., orientation, width). In other embodiments, FATE can generate corrections to non-quantized amplitude and phase states, e.g., via analog components such as phase shifter, attenuators, and variable gain amplifiers of RF channels 214 and/or other hardware components of AESA 210.

In step 308, BFICs 320 of each RF channel 240 effectuate calibrations provided by BSC 310 to generate and maintain a desired monopulse pattern according to specified mode 250.

Advantageously, method 300 allows dynamic adjustment of effective radar aperture and polarization using the fixed hardware of AESA 210. This dynamic reconfigurability of AESA 210 permits radar system 10 respond rapidly to both anticipated and emergent circumstances for improved specialized performance, e.g., to reduce power consumption where possible, improve resolution or conversely broaden beam width for object identification or detection as desired, minimize susceptibility to noise, clutter, and jamming based on specific environmental circumstances, reduce probability of intercept or detection, and/or compensate for EM saturation, all as situationally appropriate.

FIGS. 4a-4k depict examples of specific modes 250 by means of simplified aperture shapes and, in some examples, corresponding radiant plots. More specifically, FIGS. 4a-4c illustrate modes with uniformly illuminated, radially symmetric effective apertures, FIGS. 4d-4g illustrate modes with trapezoidal effective aperture geometries, FIGS. 4h-4j illustrate modes with sparse active arrays, and FIG. 4k illustrates a crossed fan beam effective aperture geometry. Common features of FIGS. 4a-4k are described together. FIGS. 4a-4k schematically illustrate modes 250 as states of AESA 210 as active and inactive portions of element plane 420. Elements 212 active in the selected mode 250 depicted with each figure make up active subsets 222a, 222b, etc. (collectively or generally, active subset(s) 222), while elements 212 deactivated in the selected mode make up inactive subsets 224b, 224d, etc. (collectively or generally, active subset(s) 224). In all instances, each inactive subset 224 is a complement to corresponding active subset 222, such that associate active subsets 222 and inactive subsets 224 do not overlap, and together constitute the entirety of elements 212 within element plane 420. Although elements 212 are depicted as forming a rectangular grid in element plane 420, it should be understood that other arrangements of elements 212 are also possible with corresponding operation of beamforming module 220 and switching module 240. In the illustrated embodiments, however, all apertures should be understood to be identically, uniformly (Nyquist) sampled in a λ/2 by λ/2 (Nyquist) rectangular grid. FIGS. 4a-4g and 4k also include radiant plots 410a-410g and 410k:0°/0° and 410k:45°/45°, respectively, (collectively or generally, radiant plots 410) illustrating sidelobe locations and amplitudes in the illustrated modes. Effective apertures illustrated in FIGS. 4a-4k can be electronically and dynamically “rotated” with respect to grid locations of elements 212 via operation of beamforming module 220. In the most general case, each mode 250 can also specify an effective aperture rotation with respect to hardware elements 212 for the purposes of composite formation of sum and difference beams, e.g., to adjust angular location of sidelobes to avoid clutter sources.

FIG. 4a illustrates modes 250 with a uniformly illuminated rectangular array. In some embodiments, FIG. 4a can depict a mode 250 wherein AESA 210 is fully loaded, i.e. such that every element 212 of AESA 210 is active (i.e., such that active subset 222a encompasses all elements 212, and inactive subset 224a is an empty set). More generally, however, active subsets 222 for all FIGS. 4a-4g can be selected, for more relevant comparison, to have substantially similar total area. In the most general case, any or all modes 250 can include a nonzero inactive subset 224 of elements 212. Although several figures presented herein illustrate uniformly illuminated geometric apertures for the sake of comparisons of effects of aperture shape on radiation pattern, the aperture patters presented herein, and more generally any or all modes 250, can arbitrarily and non-uniformly vary amplitude and phase between active elements making up any effective aperture pattern of modes 250. Uniform illumination is presented of active elements is illustrated by way of explanation, not limitation.

FIG. 4a is provided as a baseline to illustrate effects on sidelobe patterns as shown in radiant plots 410b-g, relative to radiant plot 410a. Although FIG. 4a illustrates modes 250 wherein all elements 212 are active, multiple distinct modes of matching this definition can be referenced by switching module 240, e.g., with different polarizations (circular vs. vertical vs. horizontal, for example). More generally, it should be understood that FIGS. 4a-4k only illustrate differences in aperture geometry, and that modes 250 can also constrain operation of beamforming module 220 in other ways as noted above.

The lattice of active elements 212 presented in FIG. 4a is square. Although FIGS. 4b-4k illustrate various non-rectangular effective apertures for AESA 210, variation in aperture geometry is also possible while maintaining a square or rectangular active subset 222. Conceptually, a smaller active subset 222 (square or otherwise) may in some cases be preferred despite resulting loss of resolution, for example to to reduce power consumption and/or to increase beam width for initial target detection. More practically, however, these ends can be more efficiently or effectively achieved (i.e., with less loss in resolution using the same set of elements 212) using specialized aperture patterns as mentioned below.

FIGS. 4b and 4c depict uniformly illuminated octagonal and circular effective apertures via active subsets 222b and 222c, respectively, that are maximized for these shapes. It should be understood with respect to these and other effective aperture geometries associated with modes 250 that shapes defined by active subsets 222 in element plane 420 can be “pixelated” approximations of theoretical geometric shapes based on a number of discrete elements 212 making up AESA 210. The “circular” grouping of active subset 222c, for example, is not perfectly rounded, and the descriptors for these shapes, e.g. as “circular,” “octagonal,” or “trapezoidal” are selected for convenience of explanation rather than because it is necessary for active subsets 222 to perfectly define simple Euclidian shapes.

As shown by radiant plots 410b and 410c in FIGS. 4b and 4c, blunting edges of active subset 222a into an octagon (222b) or circle (222c) increases the number of sidelobe axes while correspondingly reducing maximum sidelobe amplitude. For illustrative purposes only, in a rectangular grid of 32×32 elements 212, with an active subset 222 including the fully loaded grid of 1024 elements, a maximum sidelobe level can for example be 62.1% of a boresight amplitude at far field, while a corresponding octagonal subset 222 of 804 elements on the same 32×32 grid might have a maximum sidelobe level of 52.6% the boresight amplitude at far field. This approach comes with tradeoffs. Lower maximum side lobe amplitude can reduce clutter from sidelobe returns, but an increased number of sidelobes makes directing sidelobes away from expected clutter sources less feasible.

FIGS. 4d-4g present modes 250 with active subsets 222d-222g of elements 212 described by a non-rectangular parallelogram effective aperture geometry. As can be seen across radiant plots 410d-410g, this aperture geometry pivots cardinal plane side lobe relative to a fully loaded AESA 210. More specifically, cardinal sidelobes orientations are generally transverse to matching sides of this effective aperture, producing more pronounced pivoting of azimuth side lobes into elevation directions (in the illustrated embodiment) the greater the deviation from a rectangular aperture. Modes 250 with effective aperture geometries generally as shown in FIGS. 4d-4g can, for example, be used to dynamically direct sidelobes away from anticipated clutter or detection sources, or to maintain substantially constant cardinal sidelobe orientation relative to a geographic reference frame during aircraft maneuvers. More generally, other non-parallelogram trapezoidal shapes can also be used for similar purposes.

FIGS. 4h-4j present three thinned active subsets 222h-222j, i.e., active subsets not forming solid or uniformly illuminated geometric shapes. FIG. 4h illustrates a spiral lattice approach to AESA array thinning with a logarithmic spiral of active array elements 212 with fixed separation between spirally adjacent active elements. FIG. 4i illustrates a ring-based approach to AESA array thinning with substantially uniform spacing between circumferentially adjacent active elements, and radial spacing selected to maintain uniform sampling density as a function of angle, regardless of radial position. FIG. 4j illustrates a randomly sampled approach to AESA array thinning with a rotationally symmetric pattern, with active element pattern irregularity reducing periodicity and resulting degradation of main beam shape. Thinned (or sparse) AESA modes can be used for power aware (i.e., lower power consumption) modes 250 while also reducing sidelobe level as a fraction of borescope level. These approaches use nonadjacent or noncontiguous active subsets 222 of elements 212 selected to avoid introducing unwanted periodicity into the resulting effective aperture.

FIG. 4k provides a simplified plot illustrating a mode 250 for a crossed fan beam effective aperture geometry as disclosed, e.g., in U.S. Pat. No. 10,749,258B1, with active subset 222k of elements 212 consisting of a +-shaped uniformly illuminated collection of elements. More generally, this approach can encompass any number N of horizontal linear arrays combined with a corresponding number M of vertical linear arrays. Still more generally, these linear arrays need not be strictly vertical or horizontal with respect to the a rectangular grid of elements 212, and may instead be have any relative orientation sufficient to form a basis in element plane 420, preferably a normal basis with orthogonal linear arrays. These linear arrays can, for example, be generated in a rotated lattice architecture (e.g., angularly offset by 45° relative to the illustration of FIG. 4k) via beamforming module 220. Radiant plots 410k:0°/0° and 410k:45°/45° depict sidelobe locations and intensities at different fan beam orientations, with 410k:0°/0° corresponding to a crossed linear array scan at 0° azimuth and elevation, and 410k:45°/45° corresponding to a crossed linear array scan at 45° azimuth and elevation. This approach produces composite beam width identical to a fully loaded aperture (i.e., a narrow beam) with only partial loading of AESA 210 for reduced power consumption, although at some cost to passive aperture gain. Crossed fan beam modes as presented here can advantageously provide a broad field-of-view (with commensurate side beam width) at short range for scenarios where ground clutter is significant.

The specific aperture geometries presented in FIGS. 4a-4k are provided as examples for modes 250 with different use cases, such as reduced power consumption (FIGS. 4h-4k), sidelobe orientation (FIGS. 4d-4g) and maximum sidelobe level reduction (FIGS. 4a-4c). More generally, however, the systems and approaches set forth in FIGS. 1-3 can be advantageously used to allow fixed hardware of AESA 210 to be operated in a wide range of modes for specialized functions, and/or based on particular environmental needs.

### Discussion of Possible Embodiments

The following are non-exclusive descriptions of possible embodiments of the present invention.

A method for operating a monopulse active electronically scanned array (AESA) radar system on an aircraft, the AESA radar system including a plurality of emitter elements each having corresponding radio frequency (RF) channels including beamforming integrated circuits (BFICs), the method comprising: defining a plurality of modes, each mode defining an effective aperture by specifying a different plurality of the emitter elements; determining a preferred state of the AESA radar system based on a flight phase or environment of the aircraft; identifying one of the plurality of modes corresponding to the preferred state; calibrating beam steering, via a beam steering controller (BCM), to produce sum, azimuth difference, and elevation difference beams under the constraint of illuminating all of and only the plurality of the emitter elements corresponding to the selected one of the plurality of modes; and energizing BFICs of the plurality of the emitter elements corresponding to the selected one of the plurality of modes, according to the calibrated beam steering.

The method of the preceding paragraph can optionally include, additionally and/or alternatively, any one or more of the following features, configurations and/or additional components:

A further embodiment of the foregoing method, further comprising collecting non-radar sensor data, wherein determining the preferred state of the AESA radar system comprises evaluating the non-radar sensor data.

A further embodiment of the foregoing method, wherein determining the preferred state of the AESA radar system comprises ascertaining a mission phase of the aircraft.

A further embodiment of the foregoing method, further comprising sensing at least one of aircraft altitude, pitch, location, and landing gear status, wherein ascertaining the mission phase of the aircraft determining the mission phase from the at least one of aircraft altitude, pitch, location, and landing gear status.

A further embodiment of the foregoing method, wherein each of the plurality of modes also defines an array polarization, wherein energizing BFICs according to the calibrated beam steering comprises transmitting or receiving from each emitter at the defined array polarization.

A further embodiment of the foregoing method, wherein the plurality of modes comprises a power aware mode having a thinned effective aperture specifying a nonadjacent plurality of the emitter elements.

A further embodiment of the foregoing method, wherein the first plurality of the emitter elements comprises at least one of: a logarithmic spiral of nonadjacent emitter elements; a plurality of concentric rings of nonadjacent emitter elements, wherein a radial spacing between adjacent of the plurality of concentric rings increases as a function of radius; and a randomly sampled distribution of nonadjacent emitter elements.

A further embodiment of the foregoing method, wherein the plurality of modes comprises a crossed fan beam mode comprising a+-shaped effective aperture.

A further embodiment of the foregoing method, wherein the plurality of modes comprises a geometric illuminated aperture mode specifying an adjacent plurality of the emitter elements.

A further embodiment of the foregoing method, wherein the adjacent plurality of the emitter elements forms a circular or octagonal pattern.

A further embodiment of the foregoing method, wherein the adjacent plurality of the emitter elements forms a trapezoidal pattern.

An aerial monopulse active electronically scanned array (AESA) radar system comprising: a phased array of independently controllable radio frequency (RF) channels, each RF channel having an associated emitter element; a beamforming module comprising a beam steering controller (BSC); and a switching module, the switching module operable to dynamically select between a plurality of AESA modes, the switching module comprising a library of the plurality of AESA modes, with each of the plurality of AESA modes specifying a different subset of the RF channels to define an aperture shape by the associated emitter elements of the subset of the respective RF channels, wherein the beamforming module is constrained to illuminate all of and only the associated emitter elements of the dynamically selected AESA mode.

The aerial monopulse AESA radar system of the preceding paragraph can optionally include, additionally and/or alternatively, any one or more of the following features, configurations and/or additional components:

A further embodiment of the foregoing aerial monopulse AESA radar system, further comprising a non-radar sensor, wherein the dynamic selection between the plurality of AESA modes by the switching module is based at least in part on sensor outputs from the non-radar sensors.

A further embodiment of the foregoing aerial monopulse AESA radar system, wherein the non-radar sensor comprises at least one of an altitude sensor, an air data probe, an ice detection systems, and a landing gear status sensor.

A further embodiment of the foregoing aerial monopulse AESA radar system, wherein dynamic selection between the plurality of AESA modes by the switching module comprises identification of one of the plurality of AESA modes based at least in part on outputs of the non-radar sensor.

A further embodiment of the foregoing aerial monopulse AESA radar system, wherein all of the emitter elements are distributed on a common element plane, and wherein each of the plurality of AESA modes defines a different aperture geometry on the common element plane.

A further embodiment of the foregoing aerial monopulse AESA radar system, wherein the emitter elements are distributed on the common element plane in a grid lattice, and wherein at least a subset of the plurality of AESA modes specifies an effective aperture rotation with respect to the grid lattice.

A further embodiment of the foregoing aerial monopulse AESA radar system, wherein each of the independently controllable RF channels comprises a beamforming integrated circuit (BFIC), such that illuminating all of and only the associated emitter elements of the dynamically selected AESA mode consists of energizing only those of the independently controllable RF channels corresponding to the dynamically selected AESA mode.

A further embodiment of the foregoing aerial monopulse AESA radar system, wherein at least some of the plurality of AESA modes constitute thinned modes wherein the beamforming module is constrained to illuminate at least some noncontiguous emitter elements of the dynamically selected AESA mode.

A further embodiment of the foregoing aerial monopulse AESA radar system, wherein at least some of the plurality of AESA modes are ground clutter reduction modes selected to reduce ground clutter returns.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for operating a monopulse active electronically scanned array (AESA) radar system on an aircraft, the AESA radar system including a plurality of emitter elements each having corresponding radio frequency (RF) channels including beamforming integrated circuits (BFICs), the method comprising:
defining a plurality of modes, each mode defining an effective aperture by specifying a different plurality of the emitter elements;
determining a preferred state of the AESA radar system based on a flight phase or environment of the aircraft;
identifying one of the plurality of modes corresponding to the preferred state;
calibrating beam steering, via a beam steering controller (BCM), to produce sum, azimuth difference, and elevation difference beams under the constraint of illuminating all of and only the plurality of the emitter elements corresponding to the selected one of the plurality of modes; and
energizing BFICs of the plurality of the emitter elements corresponding to the selected one of the plurality of modes, according to the calibrated beam steering.

2. The method of claim 1, further comprising collecting non-radar sensor data, wherein determining the preferred state of the AESA radar system comprises evaluating the non-radar sensor data.

3. The method of claim 1, wherein determining the preferred state of the AESA radar system comprises ascertaining a mission phase of the aircraft.

4. The method of claim 3, further comprising sensing at least one of aircraft altitude, pitch, location, and landing gear status, wherein ascertaining the mission phase of the aircraft determining the mission phase from the at least one of aircraft altitude, pitch, location, and landing gear status.

5. The method of claim 1, wherein each of the plurality of modes also defines an array polarization, wherein energizing BFICs according to the calibrated beam steering comprises transmitting or receiving from each emitter at the defined array polarization.

6. The method of claim 1, wherein the plurality of modes comprises a power aware mode having a thinned effective aperture specifying a nonadjacent plurality of the emitter elements.

7. The method of claim 6, wherein the first plurality of the emitter elements comprises at least one of:
a logarithmic spiral of nonadjacent emitter elements;
a plurality of concentric rings of nonadjacent emitter elements, wherein a radial spacing between adjacent of the plurality of concentric rings increases as a function of radius; and
a randomly sampled distribution of nonadjacent emitter elements.

8. The method of claim 1, wherein the plurality of modes comprises a crossed fan beam mode comprising a+-shaped effective aperture.

9. The method of claim 1, wherein the plurality of modes comprises a geometric illuminated aperture mode specifying an adjacent plurality of the emitter elements.

10. The method of claim 9, wherein the adjacent plurality of the emitter elements forms a circular or octagonal pattern.

11. The method of claim 9, wherein the adjacent plurality of the emitter elements forms a trapezoidal pattern.

12. An aerial monopulse active electronically scanned array (AESA) radar system comprising:
a phased array of independently controllable radio frequency (RF) channels, each RF channel having an associated emitter element;
a beamforming module comprising a beam steering controller (BSC); and
a switching module, the switching module operable to dynamically select between a plurality of AESA modes, the switching module comprising a library of the plurality of AESA modes, with each of the plurality of AESA modes specifying a different subset of the RF channels to define an aperture shape by the associated emitter elements of the subset of the respective RF channels,
wherein the beamforming module is constrained to illuminate all of and only the associated emitter elements of the dynamically selected AESA mode.

13. The aerial monopulse AESA radar system of claim 12, further comprising a non-radar sensor, wherein the dynamic selection between the plurality of AESA modes by the switching module is based at least in part on sensor outputs from the non-radar sensors.

14. The aerial monopulse AESA radar system of claim 13, wherein the non-radar sensor comprises at least one of an altitude sensor, an air data probe, an ice detection systems, and a landing gear status sensor.

15. The aerial monopulse AESA radar system of claim 13, wherein dynamic selection between the plurality of AESA modes by the switching module comprises identification of one of the plurality of AESA modes based at least in part on outputs of the non-radar sensor.

16. The aerial monopulse AESA radar system of claim 12, wherein all of the emitter elements are distributed on a common element plane, and wherein each of the plurality of AESA modes defines a different aperture geometry on the common element plane.

17. The aerial monopulse AESA radar system of claim 12, wherein the emitter elements are distributed on the common element plane in a grid lattice, and wherein at least a subset of the plurality of AESA modes specifies an effective aperture rotation with respect to the grid lattice.

18. The aerial monopulse AESA radar system of claim 12, wherein each of the independently controllable RF channels comprises a beamforming integrated circuit (BFIC), such that illuminating all of and only the associated emitter elements of the dynamically selected AESA mode consists of energizing only those of the independently controllable RF channels corresponding to the dynamically selected AESA mode.

19. The aerial monopulse AESA radar system of claim 12, wherein at least some of the plurality of AESA modes constitute thinned modes wherein the beamforming module is constrained to illuminate at least some noncontiguous emitter elements of the dynamically selected AESA mode.

20. The aerial monopulse AESA radar system of claim 12, wherein at least some of the plurality of AESA modes are ground clutter reduction modes selected to reduce ground clutter returns.
